(19) United States
(12) Patent Application Publication
(10) Pub. No.: US 2015/0304896 A1
(43) Pub. Date: Oct. 22, 2015

(54) HANDOVER FROM D2D TO CELLULAR WHEREBY A PDCP ENTITY IS ASSOCIATED WITH TWO RLC ENTITIES RELATED TO DIFFERENT RADIO BEARERS

(71) Applicant: RENESAS MOBILE CORPORATION, Tokyo (JP)

(72) Inventors: Samuli Heikki TURTINEN, li (FI); Jukka Tapio RANTA, Kaarina (FI); Kaisu Maria IISAKKILA, Espoo (FI); Sami-Jukka Hakola, Kempele (FI); Timo Kalevi KOSKELA, Oulu (FI)

(73) Assignee: RENESAS MOBILE CORPORATION, Tokyo (JP)

(21) Appl. No.: 14/439,466

(22) PCT Filed: Oct. 24, 2013
(86) PCT No.: PCT/IB2013/059622

§ 371 Date: Apr. 29, 2015

(30) Foreign Application Priority Data
Oct. 30, 2012 (GB) 1219485.8

(51) Int. Cl. H04W 36/00; H04W 76/02

(52) U.S. Cl. CPC H04W 36/0022; H04W 36/0066; H04W 76/023

(57) ABSTRACT

The application relates to a mobile terminal radio stack for D2D single channel (308) and a cellular uplink single channel (324). A D2D connection is a direct connection formed between a first mobile terminal and a second mobile terminal over the cellular radio spectrum. The D2D connection is a local communication link and is generally enabled for use over short distances. Because the D2D connection could be lost quite rapidly, handover (e.g. bearer establishment) of the D2D communications to traditional cellular communications e.g. Evolved Universal Mobile Telecommunications System Terrestrial Radio Access Network (E-UTRAN)) may not occur in time to synchronize the multiple mobile terminals. As a result, multiple protocol data units between the mobile terminals may be lost. This problem is solved in that in response to a handover indication, the mobile terminal may then cause a PDCP entity (318) that is associated with the D2D bearer that is undergoing handover to be associated with an additional RLC entity, such as an RLC entity associated with a cellular bearer, e.g. an Evolved Packet System EPS bearer (334). SDUs received via the logical channel related to the D2D connection (314) and SDUs received via the logical channel related to the cellular connection (334) are then transmitted via the same cellular bearer (330).

### CROSS REFERENCE TO RELATED APPLICATION

This application claims the benefit under 35 U.S.C. §119(a) and 37 CFR §1.55 to UK patent application no. GB1219485.8, filed on Oct. 30, 2012, the entire content of which is incorporated herein by reference.

### TECHNICAL FIELD

Embodiments of the present invention relate generally to communications technology and, more particularly, to example packet routing during handover.

### BACKGROUND

The modern computing era has brought about a tremendous expansion in computing power as well as increased affordability of computing devices. This expansion in computing power has led to a reduction in the size of computing devices and given rise to a new generation of mobile devices that are capable of performing functionality that only a few years ago required processing power provided only by the most advanced desktop computers. Consequently, mobile computing devices having a small form factor have become ubiquitous and are used by consumers of all socioeconomic backgrounds.

As a result of the expansion in computing power and the reduction in size of mobile computing devices, mobile computing devices are being marketed with an ever increasing array of features. For example, one such feature is the ability for mobile terminals to communicate via device-to-device (D2D) connections. A D2D connection is operable to enable a mobile terminal to be in direct data communication with another mobile terminal, via the cellular spectrum, without using the one or more base stations within a cellular network. The use of D2D connections enables the transfer of data between mobile terminals over a short distance while avoiding the potential of overloading the cellular network. In future long term evolution (LTE) networks, D2D communications and local switching are to be supported.

### SUMMARY

In some example embodiments, a method of controlling transmission of data units is provided that comprises causing a cellular bearer logical channel identification to be associated with a cellular bearer. The method of this embodiment also includes reconfiguring an internet protocol flow to correspond to the cellular bearer logical channel identification and causing one or more device-to-device service data units that are scheduled to be transmitted or received via a device-to-device bearer to be transmitted or received via the cellular bearer.

In further example embodiments, an apparatus for controlling transmission of data units is provided that includes a processing system, which may be embodied by at least one processor and at least one memory including computer program code. The processing system is arranged to cause the apparatus to at least cause a cellular bearer logical channel identification to be associated with a cellular bearer. The processing system is arranged to cause the apparatus to reconfigure an internet protocol flow to correspond to the cellular bearer logical channel identification. Further, the processing system is arranged to cause the apparatus to cause one or more device-to-device service data units that are scheduled to be transmitted or received via a device-to-device bearer to be transmitted or received via the cellular bearer.

In yet further example embodiments, a computer program product for controlling transmission of data units may be provided that includes a set of instructions, which, when executed by a computing device, causes a cellular bearer logical channel identification to be associated with a cellular bearer; to reconfigure an internet protocol flow to correspond to the cellular bearer logical channel identification and to cause one or more device-to-device service data units that are scheduled to be transmitted or received via a device-to-device bearer to be transmitted or received via the cellular bearer.

In yet further example embodiments, an apparatus is provided that includes means for causing a cellular bearer logical channel identification to be associated with a cellular bearer. The apparatus of this embodiment may also include means for reconfiguring an internet protocol flow to correspond to the cellular bearer logical channel identification. The apparatus of this embodiment may also include means for causing one or more device-to-device service data units that are scheduled to be transmitted or received via a device-to-device bearer to be transmitted or received via the cellular bearer.

### BRIEF DESCRIPTION OF THE DRAWINGS

Having thus described the example embodiments of the invention in general terms, reference will now be made to the accompanying drawings, which are not necessarily drawn to scale, and wherein:

FIG. 1 is a schematic representation of a system having a mobile terminal that may benefit from some example embodiments of the present invention;

FIG. 2 is a block diagram of an apparatus that may be embodied by a mobile terminal and/or an base station in accordance with some example embodiments of the present invention;

FIGS. 3a and 3b illustrate various examples of a mobile terminal radio stack in accordance with some example embodiments of the present invention; and

FIG. 4 is a flowchart illustrating operations performed by an example mobile terminal in accordance with some example embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a)hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

As is used herein, the term “Packet Data Convergence Protocol (PDCP) entity” or “PDCP” should be understood to refer to a transmitting PDCP entity, a receiving PDCP entity and/or both. Similarly, “Radio Link Control (RLC) entity” or RLC should be understood to refer to a transmitting RLC entity, a receiving RLC entity and/or both.

A D2D connection is a direct connection formed between a first mobile terminal and a second mobile terminal over the cellular radio spectrum. The D2D connection is a local communication link and is generally enabled for use over short distances. As such, in some cases, a D2D connection between mobile terminals could fail very suddenly as a mobile terminal moves into and out of D2D communications range. In some examples, a D2D connection is occasionally broken due to the fact that a mobile terminal is at a D2D connection edge and therefore may periodically drop its D2D connection. Because the D2D connection could be lost quite rapidly, handover (e.g. bearer establishment) of the D2D communications to traditional cellular communications (e.g. Evolved Universal Mobile Telecommunications System Terrestrial Radio Access Network (E-UTRAN)) may not occur in time to synchronize the multiple mobile terminals. As a result, multiple protocol data units between the mobile terminals may be lost.

A method, apparatus and computer program product are provided herein for enabling a handover from D2D communications to cellular communications. In some example embodiments, a handover indication may be received or otherwise determined by a mobile terminal. In response and according to some example embodiments, the mobile terminal may then cause a PDCP entity that is associated with the D2D bearer that is undergoing handover to be associated with an additional RLC entity, such as an RLC entity associated with a cellular bearer (e.g. an Evolved Packet System (EPS) bearer). In some examples, the cellular bearer may be a newly created cellular bearer whereas in other examples, an existing cellular bearer may be used. The D2D bearer and the cellular bearer, in some examples, may be assigned different logical channel identifications. As such, the PDCP entity may receive Service Data Units (SDUs) from lower layers in the stack in both logical channels (e.g. a D2D logical channel and a cellular logical channel) and upon receipt; the PDCP entity may pass the correctly received SDUs via the cellular bearer for transmission via the cellular network. Similarly, the PDCP entity may receive SDUs from higher layers in the stack via the cellular bearer and may cause those SDUs to be passed to the lower levels in the stack via the appropriate logical channel (e.g. a D2D logical channel and a cellular logical channel). Alternatively or additionally, the cellular bearer may be established so as to have the same logical channel identification of the D2D bearer.

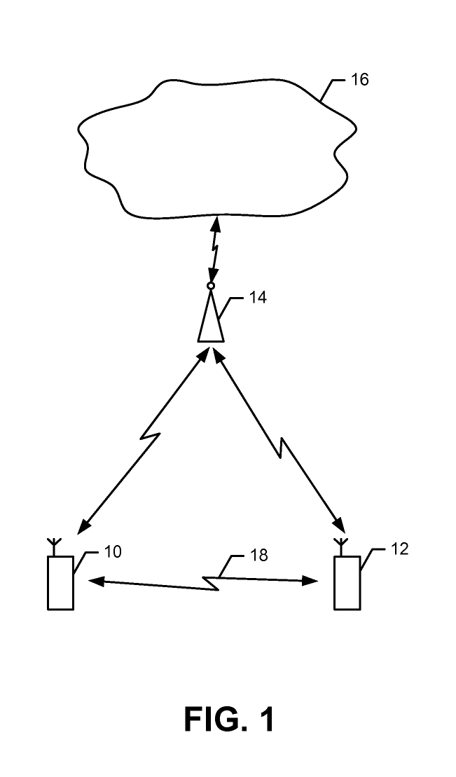

Although the method, apparatus and computer program product as described herein may be implemented in a variety of different systems, one example of such a system is shown in FIG. 1, which includes a mobile terminal (e.g., mobile terminal 10 and/or mobile terminal 12) that is capable of communication via a base station 14, such as an access point, a macro cell, a Node B, an evolved Node B (eNB), Base Transceiver Station (BTS), a coordination unit, a macro base station or other base station, with a network 16 (e.g., a core network). While the network may be configured in accordance with Global System for Mobile Communications (GSM), other networks, such as LTE™ or LTE-Advanced (LTE-A™), may support the method, apparatus and computer program product of some embodiments of the present invention including those configured in accordance with wideband code division multiple access (W-CDMA™), CDMA2000, general packet radio service (GPRS™), IEEE™ 802.11 standard for wireless fidelity (WiFi), wireless local access network (WLAN™) Worldwide Interoperability for Microwave Access (WiMAX™) protocols, and/or the like.

The network 16 may include a collection of various different nodes, devices or functions that may be in communication with each other via corresponding wired and/or wireless interfaces. For example, the network 16 may include one or more cells, including base station 14, which may serve a respective coverage area. The base station 14 may be, for example, part of one or more cellular or mobile networks or public land mobile networks (PLMNs). In turn, other devices such as processing devices (e.g., personal computers, server computers or the like) may be coupled to the mobile terminal 10, mobile terminal 12 and/or other communication devices via the network 16.

A mobile terminal, such as the mobile terminal 10 and/or mobile terminal 12 (also known as user equipment (UE), a communications device or the like), may be in communication with other mobile terminals or other devices via the base station 14 and, in turn, the network 16. In some cases, the mobile terminal 10 may include an antenna or a plurality of antennas for transmitting signals to and for receiving signals from a base station 14. Mobile terminal 10 and/or mobile terminal 12 are further configured for direct communications (e.g. D2D communications) via connection 18.

In some example embodiments, the mobile terminal 10 and/or mobile terminal 12 may be a mobile communication device such as, for example, a mobile telephone, portable digital assistant (PDA), pager, laptop computer, STA, a tablet, or any of numerous other hand held or portable communication devices, computation devices, content generation devices, content consumption devices, or combinations thereof. Other such devices that are configured to connect to the network include, but are not limited to a refrigerator, a security system, a home lighting system, and/or the like. As such, the mobile terminal 10 and/or mobile terminal 12 may include one or more processors that may define processing circuitry and a processing system, either alone or in combination with one or more memories. The processing circuitry may utilize instructions stored in the memory to cause the mobile terminal 10 and/or mobile terminal 12 to operate in a particular way or execute specific functionality when the instructions are executed by the one or more processors. The mobile terminal 10 and/or mobile terminal 12 may also include communication circuitry and corresponding hardware/software to enable communication with other devices and/or the network 16.

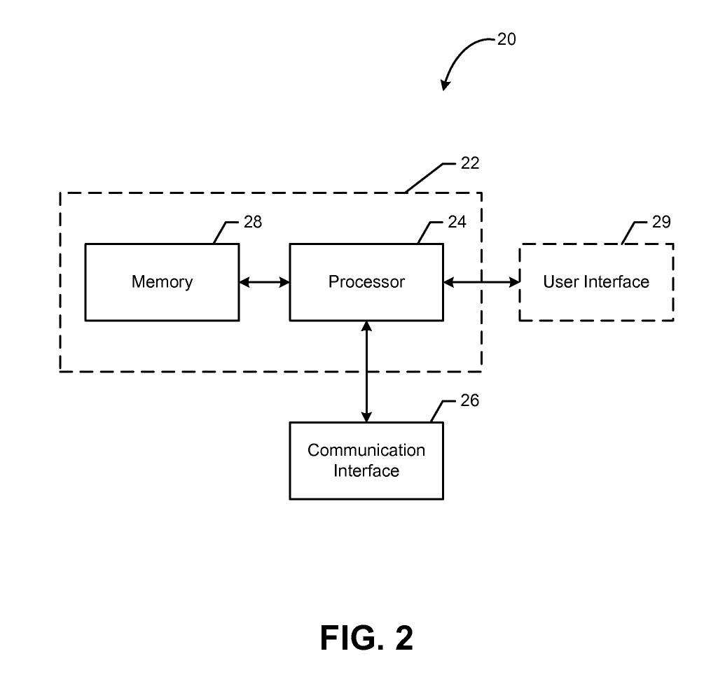

In some example embodiments, the mobile terminal 10, the mobile terminal 12 and/or the base station 14 may be embodied as or otherwise include an apparatus 20 as generically represented by the block diagram of FIG. 2. While the apparatus 20 may be employed, for example, by a mobile terminal 10, mobile terminal 12 or a base station 14, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 28 that may be in communication with or otherwise control a communication interface 26 and, in some cases, a user interface 29. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal 10, the processing circuitry may be embodied as a portion of a mobile computing device or other mobile terminal. In some examples, the processing circuitry 22 and/or the processor 24 make take the form of a processing system in some example embodiments.

The user interface 29 (if implemented) may be in communication with the processing circuitry 22 to receive an indication of a user input at the user interface and/or to provide an audible, visual, mechanical or other output to the user. As such, the user interface may include, for example, a keyboard, a mouse, a trackball, a display, a touch screen, a microphone, a speaker, and/or other input/output mechanisms. The apparatus 20 need not always include a user interface. For example, in instances in which the apparatus is embodied as a base station 14, the apparatus may not include a user interface. As such, the user interface is shown in dashed lines in FIG. 2.

The communication interface 26 may include one or more interface mechanisms for enabling communication with other devices and/or networks. In some cases, the communication interface may be any means such as a device or circuitry embodied in either hardware, or a combination of hardware and software that is configured to receive and/or transmit data from/to a network 16 and/or any other device or module in communication with the processing circuitry 22, such as between the mobile terminal 10, mobile terminal 12 and the base station 14. In this regard, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 28 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 28 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor 24 may be specifically configured hardware for conducting the operations described herein. Alternatively, as another example, when the processor 24 is embodied as an executor of software instructions, the instructions may specifically configure the processor 24 to perform the operations described herein.

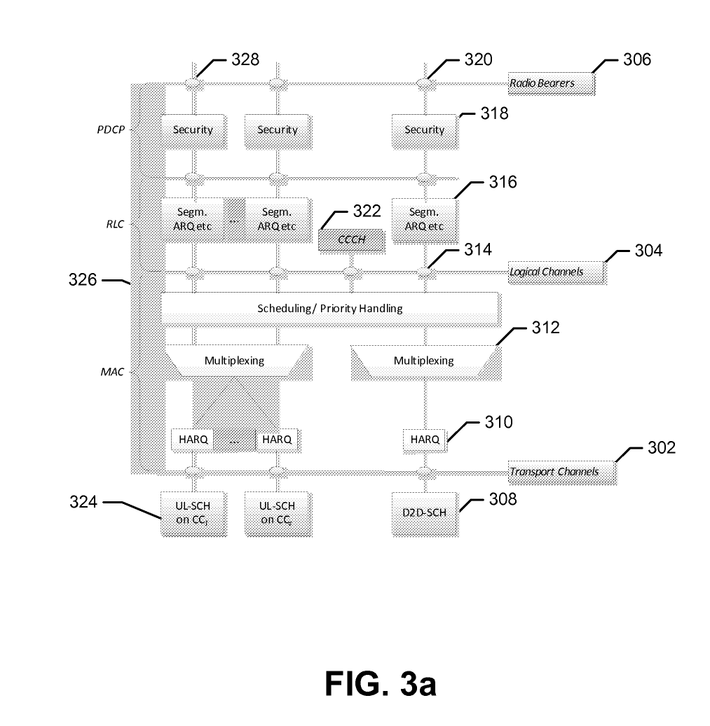

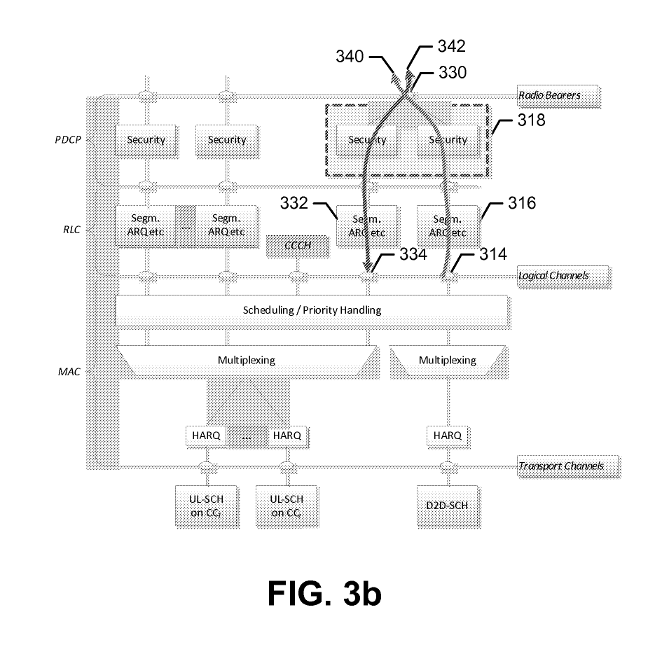

FIGS. 3a and 3b illustrate various examples of a mobile terminal radio stack in accordance with some example embodiments of the present invention. As is shown in FIG. 3a, in an instance in which a D2D connection is active, a mobile terminal radio stack operating on mobile terminal 10 and/or mobile terminal 12 may include a D2D bearer 320 that is associated with a PDCP entity 318 and a cellular bearer 326. The PDCP entity 318, may, in some examples, be associated with RLC entity 316.

The example mobile terminal radio stack for D2D single channel 308 and/or one cellular uplink single channel 324, shown with reference to FIGS. 3a and 3b, illustrates a medium access control layer (MAC), a radio link control (RLC) layer and a packet data convergence protocol (PDCP) layer. The MAC layer includes transport channels 302, a hybrid automatic repeat request (HARM) entity 310, a multiplexing entity 312 and scheduling/priority handling entity 324. The RLC layer comprises an RLC entity that provides automatic repeat request (ARQ) functionality and supports data segmentation and concatenation. The RLC layer further comprises the common control channel (CCCH) 322. The PDCP layer comprises a PDCP entity that is configured to perform a security function, such as encoding and decoding of the user plane and control plane data.

In some examples, a mobile terminal, such as mobile terminal 10 and/or mobile terminal 12, may then receive an indication or otherwise determine that a D2D connection, such as connection 18, is to be terminated or will otherwise fail. In some cases, the indication of the termination may take the form of a message or other handover notification that is received from a base station, such as base station 14, another mobile terminal, the network, such as network 16, and/or the like. In other example embodiments, the mobile terminal may determine that the D2D connection is to be terminated based on a connection status, a quality of service measure and/or the like. In some example embodiments, a handover decision may result the determination that the D2D connection is to be terminated.

In response to the indication of an impending handover or termination and as shown in FIG. 3b, a cellular bearer 330, such as an EPS bearer, may be established. In some example embodiments, a PDCP entity 318 that is already associated with RLC entity 316 may then be associated with RLC entity 332 that is related to the cellular bearer 330. As is shown in FIG. 3b, the D2D bearer, such as D2D bearer 320 of FIG. 3a, is terminated and the cellular bearer 330 is associated with logical channel 314 and logical channel 334 of the logical channels 304. In one example embodiment, RLC entity 316 and RLC entity 332 may then associate with a Medium Access Control (MAC) entity that is operable to multiplex logical channel 314 and logical channel 334 separately. Alternatively or additionally, an existing cellular bearer may be selected for use in some example embodiments (e.g. cellular bearer 328 of FIG. 3a).

In some example embodiments, the logical channel 314 is assigned or otherwise maintains an existing logical channel identification, such as a first logical channel identification, and the logical channel 334 is assigned or otherwise maintains an existing distinct logical channel identification, such as a second logical channel identification. As such, the processing circuitry 22, the processor 24 or the like may cause the outgoing higher layer internet protocol flow routing (e.g. via path 342) in the radio stack to be reconfigured to correspond to the cellular bearer 38 and the second logical channel identification.

In some example embodiments, the receiving PDCP entity may expect incoming data from lower layers in both of the logical channels (e.g. the first logical identification and the second logical identification) and then may pass the received SDUs to higher layers via the logical channel 334 of the cellular bearer 330, thereby causing the SDUs to be transmitted via the cellular bearer 330. For example, SDUs received via logical channel 314 are represented by path 340 and SDUs from received via the logical channel 334 are shown by path 342. In such cases, the SDUs still maintain the security (e.g. encryption and integrity protection) as established for the D2D connection. In some example embodiments, the D2D logical channel may be maintained until an RLC buffer has been emptied, such as an RLC buffer at each mobile terminal participating in the D2D connection, a timer expires and/or the like.

An SDU is generally assigned a sequence number (SN), however, in some example embodiments, the PDCP SN may be restarted in an instance in which cellular bearer 330 is established and begins routing data as described above. As such, the transmitting PDCP entity may associate SDUs not acknowledged by lower layers, such as lower layers corresponding to the D2D logical channel, with a new sequence number, such that SDUs having new sequence numbers are configured to be transmitted via the cellular bearer 330.

Alternatively or additionally, and as shown with reference to FIG. 3b, the logical channel 334 may be assigned the same logical channel identification as logical channel 314. In such cases, PDCP SN is continued from the terminated D2D bearer to the cellular bearer 330. As such, the processing circuitry 22, the processor 24, the communication interface 26 or the like is configured to synchronize the PDCP SN at the base station 14, a PDCP entity on a receiving mobile terminal and/or the like. Advantageously, for example, in an instance in which the same logical channel identification is used for logical channel 314 and 334, higher layer internet protocol flow routing in the radio stack does not need to be reconfigured.

In some examples, a PDCP control protocol data unit (PDU) format may be used for synchronizing the handover between a first mobile terminal, such as mobile terminal 10, and a second mobile terminal, such as mobile terminal 12, that are transitioning from a D2D connection to a cellular connection. As such, the PDCP control PDU may be transmitted from a first mobile terminal to a second mobile terminal for the purposes of synchronizing the mobile terminals for communications via a cellular bearer. In some example embodiments, the control PDU format may comprise one or more or the following non-exhaustive list: information about the SN of the last PDCP SDU to be transmitted via the D2D bearer, the SN of the first PDCP SDU to be transmitted to the cellular bearer, the SN of the last PDCP SDU that was correctly received from the D2D bearer; the SN of the first PDCP SDU that is expected to be received from the cellular bearer, the SNs of the missing PDCP SDUs the PDCP entity expects from its peer PDCP entity to be delivered via D2D bearer before handover completion and/or an indication of a window size reordering.

In some examples, the PDCP entity associated with two or more logical channels may also be associated with a timer. The timer in some example embodiments may be configured by the base station, the RLC, another mobile terminal, higher layers of the radio stack and/or the like. In one method of this embodiment, after expiry of the said timer, the D2D bearer 320 may be dropped or otherwise terminated.

In some example embodiments, the PDCP entity is configured to forward a packet discard expiry message to the lower layers for SDUs not acknowledged by lower layers before handover completion. For example, those SDUs that have not been successfully routed as described above will be indicated an expired. As such, in some examples, those SDUs may then be recreated and transmitted via the cellular bearer.

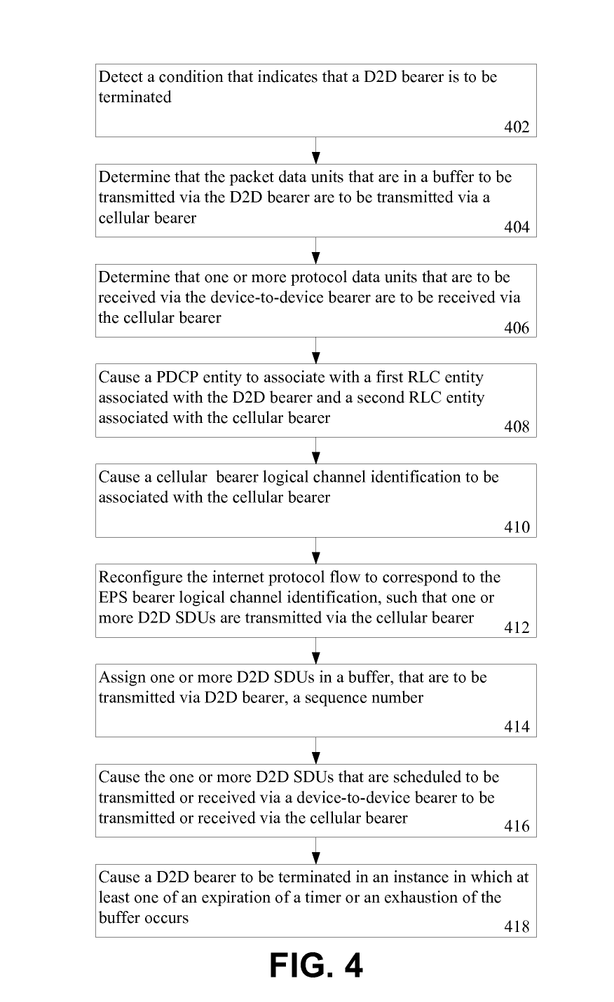

FIG. 4 illustrates example operations performed by a method, apparatus and computer program product, such as apparatus 20 of FIG. 2 in accordance with one embodiment of the present invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described herein may be embodied by computer program instructions. In this regard, the computer program instructions which embody the procedures described herein may be stored by a memory 28 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart's block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart's block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart's block(s). As such, the operations of FIG. 4, when executed, convert a computer or processing circuitry into a particular machine configured to perform an example embodiment of the present invention. Accordingly, the operations of FIG. 4 define an algorithm for configuring a computer or processing circuitry 22, e.g., processing system, to perform an example embodiment. In some cases, a general purpose computer may be provided with an instance of the processor which performs the algorithm of FIG. 4 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations herein may be modified or further amplified as described below. Moreover, in some embodiments additional optional operations may also be included. It should be appreciated that each of the modifications, optional additions or amplifications below may be included with the operations herein either alone or in combination with any others among the features described herein.

FIG. 4 is a flowchart illustrating operations performed by an example mobile terminal, such as mobile terminal 10 and/or mobile terminal 12, or a component of a mobile terminal, such as the processing circuitry 22, the processor 24, the communications interface 26, a modem and/or the like, in accordance with some example embodiments of the present invention. As is shown with respect to operation 402, the apparatus 20 embodied, for example by mobile terminal 10 and/or mobile terminal 12, may include means, such as the processing circuitry 22, the processor 24, the communication interface 26 or the like, for detecting a condition that indicates that a D2D bearer is to be terminated. As is shown with respect to operation 404, the apparatus 20 embodied, for example by mobile terminal 10 and/or mobile terminal 12, may include means, such as the processing circuitry 22, the processor 24 or the like, for determining that the protocol data units that are in a buffer to be transmitted via the D2D bearer are to be transmitted via a cellular bearer (e.g. an EPS bearer). As is shown with respect to operation 406, the apparatus 20 embodied, for example by mobile terminal 10 and/or mobile terminal 12, may include means, such as the processing circuitry 22, the processor 24 or the like, for determining that one or more protocol data units that are to be received via the device-to-device bearer are to be received via the cellular bearer (e.g. an EPS bearer).

As is shown with respect to operation 408, the apparatus 20 embodied, for example by mobile terminal 10 and/or mobile terminal 12, may include means, such as the processing circuitry 22, the processor 24 or the like, for causing a PDCP entity to associate with a first RLC entity that is associated with a D2D bearer and a second RLC entity that is associated with an cellular bearer. As is shown with respect to operation 410, the apparatus 20 embodied, for example by mobile terminal 10 and/or mobile terminal 12, may include means, such as the processing circuitry 22, the processor 24 or the like, for causing an cellular bearer logical channel identification to be associated with the cellular bearer. In some example embodiments, the logical channel identification may be different from the logical channel identification assigned to the

D2D bearer. As is shown with respect to operation 412, the apparatus 20 embodied, for example by mobile terminal 10 and/or mobile terminal 12, may include means, such as the processing circuitry 22, the processor 24 or the like, for reconfiguring the internet protocol flow to correspond to the cellular bearer logical channel identification, such that one or more D2D SDUs are transmitted via the EPS bearer. In examples in which the D2D bearer logical channel and the cellular bearer logical channel share a channel identification, the internet protocol follow may, for example, not need to be reconfigured.

As is shown with respect to operation 414, the apparatus 20 embodied, for example by mobile terminal 10 and/or mobile terminal 12, may include means, such as the processing circuitry 22, the processor 24 or the like, for assigning one or more D2D SDUs in a buffer, that are to be transmitted via D2D bearer, a sequence number. As is shown with respect to operation 416, the apparatus 20 embodied, for example by mobile terminal 10 and/or mobile terminal 12, may include means, such as the processing circuitry 22, the processor 24 or the like, for causing the one or more D2D SDUs that are scheduled to be transmitted or received via a device-to-device bearer to be transmitted or received via the cellular bearer. As is shown with respect to operation 418, the apparatus 20 embodied, for example by mobile terminal 10 and/or mobile terminal 12, may include means, such as the processing circuitry 22, the processor 24 or the like, for causing a D2D bearer to be terminated in an instance in which at least one of an expiration of a timer or an exhaustion of the buffer occurs.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method of controlling transmission of data units, the method comprising:
causing a cellular bearer logical channel identification to be associated with a cellular bearer;
reconfiguring an internet protocol flow to correspond to the cellular bearer logical channel identification; and
causing one or more device-to-device service data units that are scheduled to be transmitted or received via a device-to-device bearer to be transmitted or received via the cellular bearer.

2. A method according to claim 1, wherein the cellular bearer logical channel identification is different from a device-to-device bearer logical channel identification associated with the device-to-device bearer.

3. A method according to claim 1, wherein the cellular bearer logical channel identification and a device-to-device bearer logical channel identification associated with a device-to-device bearer share a logical channel identification.

4-14. (canceled)

15. An apparatus for controlling transmission of data units, the apparatus comprising:
a processing system arranged to cause the apparatus to at least:
cause a cellular bearer logical channel identification to be associated with a cellular bearer;
reconfigure an internet protocol flow to correspond to the cellular bearer logical channel identification; and
cause one or more device-to-device service data units that are scheduled to be transmitted or received via a device-to-device bearer to be transmitted or received via the cellular bearer.

16. An apparatus according to claim 15, wherein the cellular bearer logical channel identification is different from a device-to-device bearer logical channel identification associated with the device-to-device bearer.

17. An apparatus according to claim 15, wherein the cellular bearer logical channel identification and a device-to-device bearer logical channel identification associated with a device-to-device bearer share a logical channel identification.

18. An apparatus according to claim 15, wherein the processing system is arranged to cause the apparatus to:
detect a condition that indicates that the device-to-device bearer is to be terminated;
determine that one or more protocol data units that are in a buffer to be transmitted via the device-to-device bearer are to be transmitted via the cellular bearer; and
determine that one or more protocol data units that are to be received via the device-to-device bearer are to be received via the cellular bearer.

19. An apparatus according to claim 18, wherein the processing system is arranged to cause the apparatus to:
cause a packet data convergence protocol entity to associate with a first radio link control entity associated with the device-to-device bearer and a second radio link control entity associated with the cellular bearer.

20. An apparatus according to claim 19, wherein the first radio link control entity and the second radio link control entity are configured to associate with a medium access control entity, and wherein the medium access control entity is configured to multiplex one or more logical channels separately.

21. An apparatus according to claim 19, wherein the packet data convergence protocol entity is configured to receive incoming service data units from a logical channel associated with the device-to-device bearer and from a logical channel associated with the cellular bearer.

22. An apparatus according to claim 15, wherein the processing system is arranged to cause the apparatus to:
assign a sequence number to one or more device-to-device service data units currently in a buffer to be transmitted via the device-to-device bearer; and
cause the one or more device-to-device service data units in the buffer that have not been acknowledged to be routed via the cellular bearer.

23. An apparatus according to claim 22, wherein the sequence number is configured to identify the one or more device-to-device service data units that are to be transmitted via the cellular bearer.

24. An apparatus according to claim 22, wherein the sequence number is configured to identify the one or more device-to-device service data units that are received via the cellular bearer.

25. An apparatus according to claim 15, wherein the processing system is arranged to cause the apparatus to:
cause the device-to-device bearer to be terminated in an instance in which at least one of an expiration of a timer occurs or an exhaustion of one or more device-to- device service data units in a buffer occurs.

26. An apparatus according to claim 25, wherein the timer is configured by at least one of a higher layer or by a radio resource control.

27. An apparatus according to claim 15, wherein a packet data convergence protocol control protocol data unit is configured to synchronize handover between one or more device-to-device mobile terminals.

28. An apparatus according to claim 15, the cellular bearer logical channel identification is an evolved packet system bearer logical channel identification and the cellular bearer is an evolved packet system bearer.

29. An apparatus according to claim 15, wherein the apparatus comprises at least one of a user equipment or a communications device.

30. An apparatus according to claim 15, wherein the apparatus is configured for use in at least one of global system for mobile communications, wideband code division multiple access, time division synchronous code division multiple access, a long term evolution or long term evolution advanced system.

31. A computer program product for controlling transmission of data units, the computer program product comprising a set of instructions, which, when executed by a computing device, causes the computing device to:
cause a cellular bearer logical channel identification to be associated with a cellular bearer;
reconfigure an internet protocol flow to correspond to the cellular bearer logical channel identification; and
cause one or more device-to-device service data units that are scheduled to be transmitted or received via a device-to-device bearer to be transmitted or received via the cellular bearer.

32-42. (canceled)
